(19) United States
(12) Patent Application Publication
(10) Pub. No.: US 2024/0283084 A1
(43) Pub. Date: Aug. 22, 2024

(54) BATTERY DEVICE

(71) Applicant: SK On Co., Ltd., Seoul (KR)

(72) Inventors: Suk Ho SHIN, Daejeon (KR); Min Song KANG, Daejeon (KR); Ji Woong KIM, Daejeon (KR); Byeong Jun PAK, Daejeon (KR); Ju Yong PARK, Daejeon (KR); Kang SAGONG, Daejeon (KR); Sol San SON, Daejeon (KR)

(21) Appl. No.: 18/407,442

(22) Filed: Jan. 9, 2024

(30) Foreign Application Priority Data
Feb. 17, 2023 (KR) 10-2023-0021667

(51) Int. Cl. H01M 50/383; H01M 50/211; H01M 50/289; H01M 50/30; H01M 50/505

(52) U.S. Cl. CPC H01M 50/383; H01M 50/211; H01M 50/289; H01M 50/394; H01M 50/505

(57) ABSTRACT

A battery device is disclosed, the battery device may include: a cell stack in which a plurality of battery cells are stacked; and a case accommodating the cell stack therein, wherein the case may have a plurality of first venting holes formed in an upper plate covering an upper surface of the cell stack, and have a plurality of second venting holes formed in a side plate covering a first side surface of the cell stack.

### CROSS-REFERENCE TO RELATED APPLICATION(S)

This patent document claims the priority and benefits of Korean Patent Application No. 10-2023-0021667 filed on Feb. 17, 2023, the disclosure of which is incorporated herein by reference in its entirety.

### TECHNICAL FIELD

This disclosure relates to a battery device for improving safety.

### BACKGROUND

Unlike primary batteries, secondary batteries may be charged with and discharged of electricity, so secondary batteries may be applied to devices within various fields such as digital cameras, mobile phones, laptop computers, hybrid cars, and electric vehicles. Among the secondary batteries, a large amount of research has been conducted into lithium secondary batteries with high energy density and discharge voltage. Lithium secondary batteries are manufactured as pouch-type battery cells having flexibility, or prismatic battery cells or cylindrical can-type battery cells having rigidity.

A plurality of battery cells are mounted on a case in a unit of cell stacks, which are stacked and electrically connected to each other to form a battery module or pack. These battery devices are commonly installed and used in electric vehicles, or the like.

However, in such a conventional battery device, when one cell stack ignites, heat or flames may be easily transferred to adjacent cell stacks, which may cause secondary ignition or explosion. Therefore, a battery device that can prevent secondary ignition or explosions is required.

### SUMMARY

According to an aspect of the present disclosure, it is possible to prevent secondary ignition or explosions from occurring due to flame or high-temperature gas generated within a battery device.

The battery device of the present disclosure may be widely applied to green technology fields such as electric vehicles, battery charging stations, solar power generation, wind power generation using other batteries, and the like. In addition, the battery device of the present disclosure may be used in eco-friendly electric vehicles, hybrid vehicles, or the like, to help mitigate climate change by suppressing air pollution and greenhouse gas emissions.

In an embodiment of the present disclosure, a battery device may include: a cell stack in which a plurality of battery cells are stacked and a case for accommodating the cell stack therein, wherein the case may have a plurality of first venting holes formed in an upper plate covering an upper surface of the cell stack, and have a plurality of second venting holes formed in a side plate covering a first side surface of the cell stack.

In an embodiment, the cell stack may include a plurality of barrier members disposed between the plurality of battery cells to form a plurality of compartments S, at least one battery cell among the battery cells may be disposed in one of the compartments S, and the plurality of first venting holes and the plurality of second venting holes may be disposed in respective positions corresponding to each of the compartments S.

In an embodiment, in one of the compartment S, at least two first venting holes among the first venting holes and at least one second venting hole among the second venting holes may be disposed to correspond to each other.

In an embodiment, the battery device may further include a blocking member disposed between the upper plate and the cell stack, wherein the blocking member may be formed in a form of sheets covering an entire upper surface of the cell stack, and may be disposed to contact upper ends of the barrier members.

In an embodiment, a portion of the blocking member, in contact with the barrier members may be compressed and elastically deformed by the barrier members.

In an embodiment, the blocking member may include a fire-resistant foam pad or ceramic wool.

In an embodiment, the battery device may further include a first protective sheet disposed between the blocking member and the upper plate, wherein the first protective sheet may include a fractured portion located in a portion of the first protective sheet corresponding to the first venting holes and fractured at a lower pressure than other portions of the first protective sheet.

In an embodiment, the first protective sheet may include a high-temperature fire-resistant insulating paper.

In an embodiment, the battery device may further include a second protective sheet disposed on an external surface of the upper plate, wherein a portion of the second protective sheet corresponding to the first venting holes may be open.

In an embodiment, the second protective sheet may include a mica sheet.

In an embodiment, the plurality of barrier members may be formed of a material containing at least one of mica, metal, and a resin.

In an embodiment, the battery device may further include a busbar assembly disposed between the side plate and the cell stack, and a busbar cover disposed between the busbar assembly and the side plate, wherein the busbar cover may include a plurality of venting guides formed in a form of through-holes, and the second venting holes may be disposed in a region corresponding to the plurality of venting guides.

In an embodiment, the battery device may further include an anti-diffusion pad coupled to the busbar cover in a form of blocking the plurality of venting guides and suppressing a flow of flame or dust.

In an embodiment, the anti-diffusion pad may include a mesh network formed of ceramic wool or metal.

In an embodiment, the case may include a support frame disposed below the cell stack to partially support a lower surface of the cell stack, and a portion of the lower surface of the cell stack may be exposed externally of the case.

In an embodiment, in the upper plate, a total area of openings formed by the first venting holes may be 40% or more, as compared to a total area of the upper plate.

### BRIEF DESCRIPTION OF DRAWINGS

Certain aspects, features, and advantages of the present disclosure are illustrated by the following detailed description with reference to the accompanying drawings.

FIG. 1 is a perspective view schematically illustrating a battery device according to an embodiment.

FIG. 2 is a perspective view illustrating the battery device of FIG. 1 in another direction.

FIG. 3 is a bottom perspective view illustrating the battery device illustrated in FIG. 1.

FIGS. 4 and 5 are exploded perspective views of the battery device illustrated in FIG. 1.

FIG. 6 is a cross-sectional view taken along line I-I′ of FIG. 1.

FIG. 7 is a perspective view of the first case and the second protective sheets illustrated in FIG. 6.

### DETAILED DESCRIPTION

Hereinafter, embodiments of the present disclosure disclosed in this patent document are described by example embodiments with reference to the accompanying drawings. In addition, in the following description, expressions such as upper side, upper portion, lower side, lower portion, side surface, and the like are illustrated based on the drawings, and may be expressed differently if the direction of the object is changed.

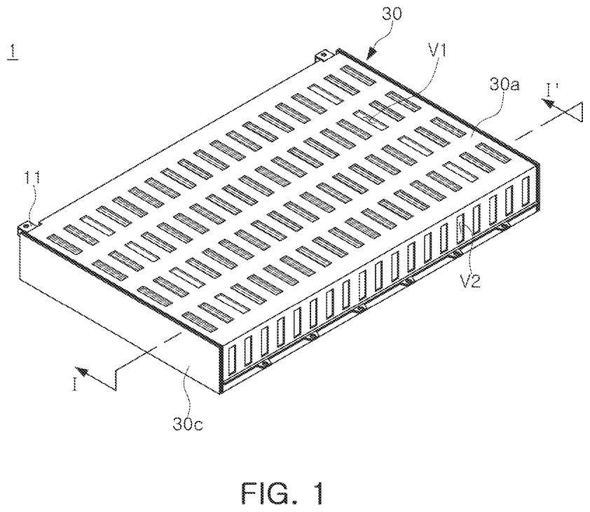

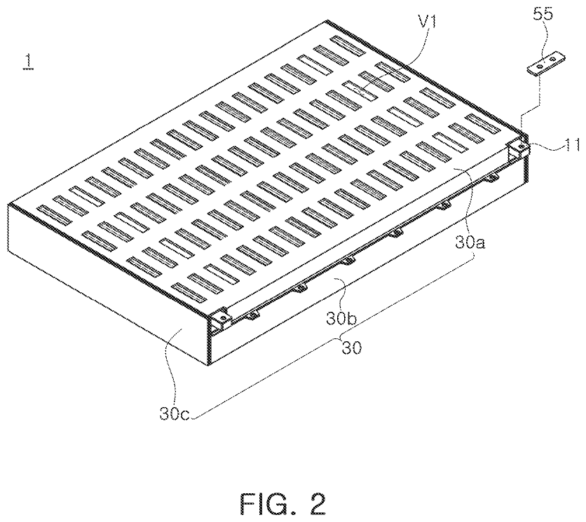

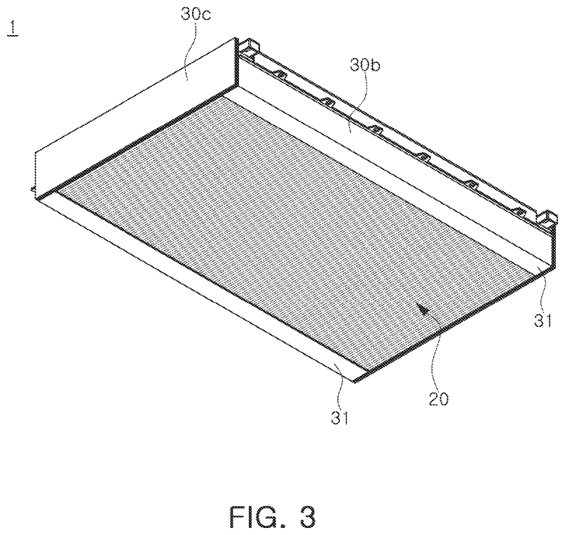

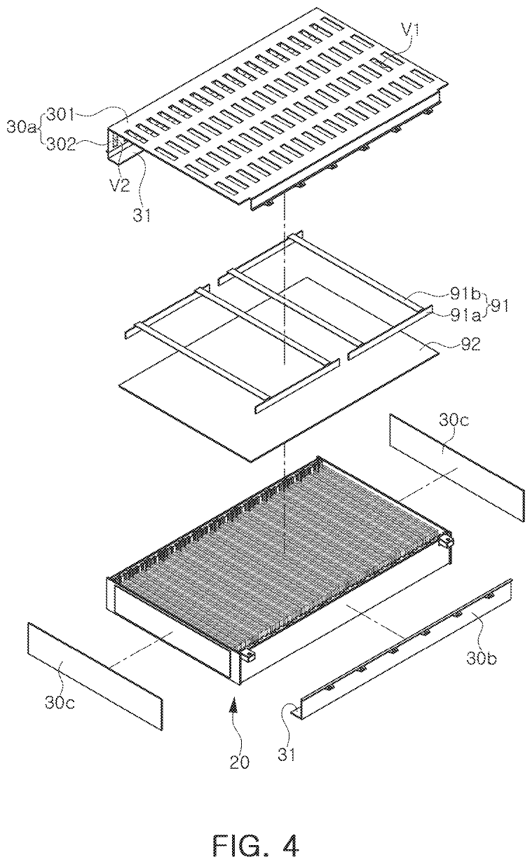

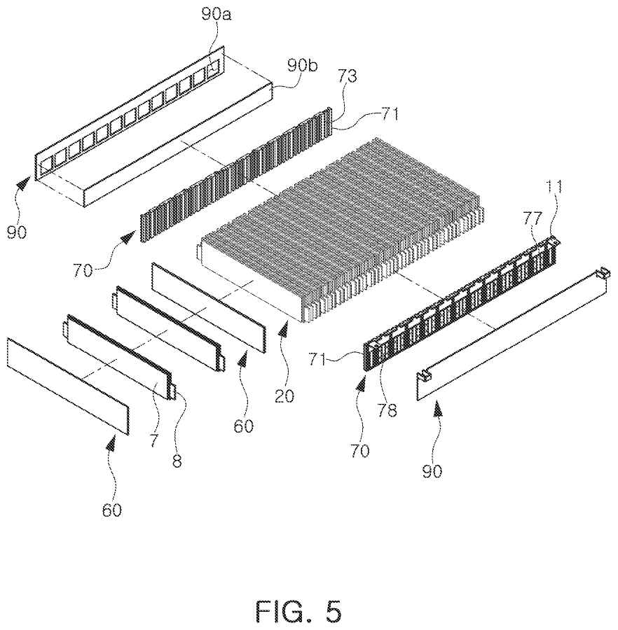

FIG. 1 is a perspective view schematically illustrating a battery device according to an embodiment, FIG. 2 is a perspective view illustrating the battery device of FIG. 1 in another direction, and FIG. 3 is a bottom perspective view illustrating the battery device illustrated in FIG. 1. In addition, FIGS. 4 and 5 are exploded perspective views of the battery device illustrated in FIG. 1.

Referring to FIGS. 1 to 5, a battery device 1 according to the present embodiment may include a secondary battery cell such as a lithium battery or nickel-hydrogen battery capable of being charged and discharged. A cell stack 20 in which a plurality of battery cells 7 are stacked, may be formed in a hexahedral shape, and may be accommodated in a case 30 or fixed in a stacked state by a bracket or the like.

The case 30 may define an external shape of the battery device 1, and may be disposed outside the cell stack 20 to protect the cell stack 20 from an external environment. At the same time, the case 30 of the present embodiment may also be used as a heat dissipation member of the cell stack 20.

The case 30 may be provided in a form of partially surrounding the cell stack 20. The case 30 may be formed of a metal material to ensure rigidity, but the present disclosure is not limited thereto. In addition, in order to increase a heat dissipation effect, at least a portion of the case 30 may be formed of aluminum.

For ease of manufacturing of the battery device 1, the case 30 may be divided into a plurality of cases. The case 30 of the present embodiment may include a first case 30a covering an upper portion and a first side surface of the battery device 1, a second case 30b covering a second side surface, opposite to the first side surface, and a third case 30c covering the remaining side surface.

The first case 30a may include an upper plate 301 covering an upper surface of the battery device 1 and a side plate 302 covering a first side surface.

The upper plate 301 may be formed to cover an entire upper surface of the cell stack 20, and a plurality of first venting holes V1 may be formed therein.

In the present embodiment, the first venting holes V1 may be formed as rectangular through-holes, and a plurality of first venting holes V1 may be distributed throughout the upper plate 301 and disposed. Accordingly, a portion of gas generated in the cell stack 20 may pass through the first venting holes V1 and be discharged externally of the battery device 1. However, the configuration of the present disclosure is not limited thereto, and it is also possible to form the plurality of first venting holes V1 to be concentrated in a specific region.

The side plate 302 may be formed to extend from the upper plate 301 and may be disposed on a first side surface of the cell stack 20 on which electrode leads 8 are disposed.

A plurality of second venting holes V2 may be formed in the side plate 302. The plurality of second venting holes V2 may be distributed and disposed side by side in a longitudinal direction of the side plate 302. In the present embodiment, each of the second venting holes V2 may be formed as rectangular through-holes, but the configuration of the present disclosure is not limited thereto.

When an amount of gas discharged from the cell stack 20 is rather large, gas may not be easily discharged only through the first venting holes V1. In addition, even when the first venting holes V1 in the cell stack 20 is blocked by dust or the like, the gas may not be easily discharged. In consideration thereof, the battery device 1 of the present embodiment may be provided with a second venting holes V2.

A portion of the gas generated in the cell stack 20 may pass through the second venting holes V2 and be discharged externally of the battery device 1. Accordingly, in the battery device 1 of the present embodiment, gas may be dispersed and discharged through the first venting holes V1 and the second venting holes V2.

Meanwhile, in the present embodiment, the first venting hole V1 and the second venting holes V2 may be disposed to discharge gas in different directions. For example, the first venting holes V1 and the second venting holes V2 may be disposed to discharge gas in a direction perpendicular to each other. However, the present disclosure is not limited thereto.

In the present embodiment, the side plate 302 is formed integrally with the upper plate 301. For example, one sheet of metal plate may be bent and divided into a side plate 302 and an upper plate 301. However, the configuration of the present disclosure is not limited thereto, and it may also be prepared separately, respectively, and may be coupled with each other.

In addition, in the present embodiment, the first case 30a may include steel or stainless steel. Since steel or stainless steel is not easily deformed, even in a high temperature environment, deformation of the upper plate 301 may be minimized even if high temperature gas or flame is discharged from the cell stack 20. Accordingly, it is possible to prevent gas or flame from being discharged in an unintended direction other than the first venting holes V1. Meanwhile, in the present embodiment, a case in which the entire first case 30a is formed of the same material is provided as an example, but the upper plate 301 and the side plate 302 may also be formed of different materials, as required. For example, various modifications may be performed as required, for example, the upper plate 301 is formed of steel or stainless steel, and the side plate 302 is formed of aluminum.

The second case 30b may be disposed on a second side surface, opposite to the first side surface on which the side plate 302 is disposed. In the present embodiment, the battery cells 7 have electrode leads 8 disposed in both directions, and within the cell stack 20, each of the battery cells 7 has electrode leads 8 disposed to face a first side surface and a second side surface. Accordingly, the second case 30b may be disposed to face the electrode leads 8 of the battery cells 7.

In the battery device 1 of the present embodiment, a terminal 11 electrically connected to the outside may be disposed on the second side surface. Therefore, the second case 30b may be understood as an element disposed on the side surface on which the terminal 11 is disposed.

Meanwhile, at least a portion of the side plate 302 and the second case 30b may be disposed on a lower surface of the battery device 1 to support the battery device 1. Specifically, the side plate 302 and the second case 30b may include a support frame 31 extending to a lower portion of the battery device 1 to partially support the lower surface of the battery device 1.

The support frame 31 may partially support a pouch region in which an electrode assembly is stored in the battery cell 7 constituting the battery device 1. Therefore, both ends of all battery cells 7 constituting the battery device 1 may be seated on the support frame 31, respectively, and a portion of the lower surface of the battery device 1 may be exposed externally of the case 30.

Through such a configuration, the battery device 1 of the present embodiment may prevent the battery device 1 from leaving a lower portion of the case 30 by the support frame 31 even if the case 30 does not block an entire lower portion of the battery device 1. As described above, when the lower portion of the battery device 1 is partially open, heat generated in the battery device 1 may be effectively discharged through the open region. In addition, a weight of the battery device 1 may be minimized.

In the present embodiment, the support frame 31 may be integrally formed with a side plate 302 and a second case 30b, or may be manufactured separately and coupled to the side plate 302 or the second case 30b.

A third case 30c may cover side surfaces of the battery device 1 on which electrode leads 8 are not disposed, that is, both side surfaces on which a busbar assembly 70, to be described later, is not disposed. The third case 30c may be fixedly fastened to the first case 30a and the second case 30b.

The first case 30a, the second case 30b, and the third case 30c may be formed of a metal material, but the present disclosure is not limited thereto, and may be partially or entirely formed of an insulating material such as a resin, if necessary. In addition, the first case 30a, the second case 30b, and the third case 30c may be coupled by welding, or the like. However, the present disclosure is not limited thereto, and various modifications may be performed, such as being coupled in a sliding manner or being coupled using a fastening member such as bolts, screws, or the like.

As illustrated in FIGS. 4 and 5, a cell stack 20, a busbar assembly 70, and a busbar cover 90 may be disposed inside the case 30.

The cell stack 20 may be formed in a hexahedral shape by stacking a plurality of battery cells 7, and the stacked state may be fixed. In the present embodiment, the battery cells 7 are stacked on each other in a thickness direction.

The battery cell 7 may be formed by accommodating an electrode assembly in a pouch-shaped cell case. In the present embodiment, the cell case can be formed by forming a single sheet of exterior material. More specifically, the cell case may be completed by forming one or two groove portions in one exterior material, and then folding the exterior material so that the groove portions form one space (hereinafter referred to as an accommodation portion). The accommodation portion may include an electrode assembly and an electrolyte solution. Meanwhile, the present disclosure is not limited to the above-described configuration, and it is also possible to form a cell case by bonding two exterior materials to each other.

Each of the battery cells 7 may be a pouch-type secondary battery, and may have a structure in which electrode leads 8 are disposed to face in opposite directions. Each of the battery cell 7 may be a secondary battery capable of repeated being charged and discharged, and may be a lithium (Li) battery or a nickel-hydrogen (Ni-MH) battery.

At least one barrier member 60 may be disposed between the battery cells 7.

The barrier member 60 may be provided to prevent explosive by-products, such as flame or gas, from exploding when one battery cell 7 explodes and diffuses to other surrounding battery cells 7. To this end, a plurality of barrier members 60 may be disposed to be spaced apart from each other and interposed between the battery cells 7, and ends of the barrier members 60 may be coupled to the busbar assembly 70. Accordingly, the battery cells 7 on both sides of one barrier member 60 may be spatially separated, and accordingly, even if the battery cell 7 in one region explodes, an influence on the battery cell 7 in other regions may be minimized.

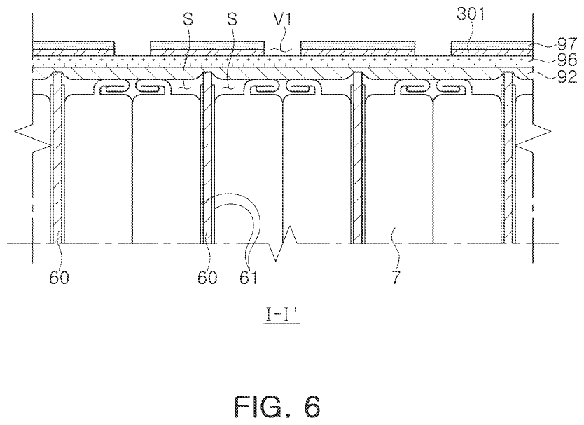

FIG. 6 is a partial cross-sectional view taken along line I-I′ of FIG. 1, and referring to FIG. 6, the cell stack 20 of the present embodiment may be divided into a plurality of compartments S, and each of the compartments S may be defined as a space between two barrier members 60.

One or a plurality of battery cells 7 may be disposed in each of the compartments S. In the present embodiment, two battery cells 7 are disposed in one of the compartments S. However, the configuration of the present disclosure is not limited thereto, and the number of battery cells 7 disposed between the barrier members 60 may be changed as required.

The barrier member 60 may be formed of a material including at least one of mica, metal, and a resin. Here, the mica, metal, and resin are materials that are not easily melted by high-temperature flame, gas, or the like. For example, the mica, metal, and resin may be materials that melt at 700° C. or higher.

For example, the metal material may be formed of a material such as iron (Fe), copper (Cu), aluminum (Al), or a metal alloy, and may be heat treated. As the resin material, flame retardant plastic, which is a synthetic resin, may be used. In addition, the mica, metal, and resin may be synthesized or mixed to form a barrier member 60.

A buffer pad 61 compressed to a certain thickness by external force may be provided on an external surface of the barrier member 60. The buffer pad 61 may be compressed and elastically deformed when the battery cell 7 expands due to swelling. Therefore, even if one of the battery cells 7 expands, expansion of an overall volume of the cell stack 20 may be minimized. The buffer pad 61 may be formed of a foam-type material such as polyurethane foam (PU foam), or the like, but the present disclosure is not limited thereto.

The busbar assembly 70 may be disposed on a side surface of the battery cells 7 on which electrode leads 8 are disposed, respectively, and coupled to the cell stack 20, and each busbar assembly 70 may include at least one busbar 77 and an insulating frame 71.

The insulating frame 71 may be formed of an insulating material, and may be formed in a size corresponding to an entire side surface of the cell stack 20 that the busbar assembly 70 faces.

At least one busbar 77 and a terminal 11 may be fixed and coupled to an external surface (hereinafter referred to as a first surface) of the insulating frame 71, and a second surface, opposite to the first surface, may face the cell stack 20.

The insulating frame 71 may be provided with a plurality of through-holes 73 into which electrode leads 8 are inserted, and the electrode leads 8 may pass through the through-holes 73 and be coupled to the busbar 77.

The busbar 77 may be formed in a form of a conductive metal plate, and at least a portion of the busbar 77 may be embedded in an inside of the insulating frame 71 or may be coupled to an external surface of the insulating frame 71. The battery cells 7 may be electrically connected to each other through the busbar 77. To this end, a plurality of through slits 78 into which electrode leads 8 are inserted may be formed in the busbar 77, and the electrode leads 8 may be inserted into the through slits 78 of the busbar 77 and be then bonded to the busbar 77 through a method such as welding, or the like. Accordingly, at least a portion of ends of the electrode leads 8 may completely penetrate through the busbar 77 and be exposed externally of the busbar 77.

A plurality of busbars 77 may be disposed in parallel to be spaced apart in a stacking direction of the battery cells 7, and at least two battery cells 7 may be coupled to one busbar 77.

A terminal 11 may be provided on at least one among the busbar assemblies 70. The terminal 11 is a member electrically connected to the busbar 77, and may be formed of a conductive member exposed externally of the case 30 of the battery device 1 and may be physically/electrically connected to at least one among the busbars 77. For example, the terminal 11 may be formed integrally with one among the busbars busbar 77. However, the present disclosure is not limited thereto, and the terminal 11 may also be formed separately from the busbar 77 and coupled to the insulating frame 71, and then the busbar 77 and the terminal 11 may be electrically connected.

An external connection member 55 may be fastened to the terminal 11. The external connection member 55 may connect one battery device 1 and the terminal 11 of an adjacent battery device 1.

Both ends of the external connection member 55 may be respectively fastened to the terminal 11 of the battery devices 1, different from each other, through a fastening member such as a bolt.

When using a plurality of battery devices 1 of the present embodiment, each of the plurality of battery devices 1 may be connected to each other in series or parallel through an external connection member 55. In addition, if necessary, a portion of the battery devices 1 may be connected in series and portion of the battery devices 1 may be connected in parallel.

The external connection member 55 may be formed by processing a flat rod-shaped conductive member. In addition, the external connecting member 55 may be formed of a flexible material. However, the configuration of the present disclosure is not limited thereto, and wires or cables may also be used as the external connection member 55.

A busbar cover 90 may be interposed between the case 30 and the cell stack 20. In the present embodiment, the busbar cover 90 may include a first busbar cover interposed between the side plate 302 of the first case 30a and the cell stack 20 and a second busbar cover interposed between the second case 30b and the cell stack 20.

The busbar cover 90 may be formed of an insulating material such as a resin and may be disposed between a busbar assembly 70 and the side plate 302, and between the busbar assembly 70 and the second case 30b. Therefore, each of the busbar covers 90 may be disposed so that one surface of the busbar cover 90 faces the busbar assembly 70 and the other surface thereof faces the side plate 302 or the second case 30b, and may be coupled to the busbar assembly 70 to cover the entire busbar 77.

The busbar cover 90 may be provided to ensure insulation between the busbar 77 and the case 30. Therefore, the busbar cover 90 may be formed in various shapes as long as the busbar cover 90 covers the entire busbars 77.

At least one venting guide 90a may be provided on a busbar cover 90 among the busbar covers 90, which is disposed to face the second venting holes V2. The venting guide 90a may be formed in a form of holes penetrating through the busbar cover 90, and may be used as a passage through which gas generated in the battery cells 7 is discharged externally of the busbar cover 90.

A plurality of venting guides 90a may be disposed in parallel, and may be disposed in a position corresponding to the second venting holes V2. Accordingly, the gas generated in the battery cell 7 may sequentially pass through the venting guide 90a and the second venting holes V2 and be discharged externally of the battery device 1.

Meanwhile, in order to prevent flame or dust generated in the battery cell 7 from diffusing externally through the venting guide 90a, an anti-diffusion pad 90b may be coupled to the venting guide 90a. In the present embodiment, the anti-diffusion pad 90b is formed as one piece and is coupled to block the entire venting guide 90a. However, the present disclosure is not limited thereto, and the plurality of anti-diffusion pads 90b may also be coupled to each of the venting guides 90a, if necessary.

The anti-diffusion pad 90b may be formed of a mesh network formed of ceramic wool or metal. Ceramic wool or mesh network may be formed into a form of a very fine filter to suppress a flow of flames, dust, or the like, and be formed to allow only gas or smoke to pass therethrough. Accordingly, flames or dust diffusing from the battery cell 7 may be blocked from diffusing externally by the anti-diffusion pad 90b.

In addition, the battery device 1 may include a sensing unit 91, a blocking member 92, a first protective sheet 96, and a second protective sheet 97.

As illustrated in FIG. 4, the sensing unit 91 may be coupled to an external surface of the busbar assembly 70 and may sense a voltage of the battery cell 7. For example, the sensing unit 91 may include a plurality of sensing terminals 91a connected to a busbar and a circuit board 91b connecting sensing terminals to each other.

The blocking member 92 may be disposed between an upper plate 301 of the first case 30a and may be formed in a form of sheets covering an entire upper surface of the cell stack 20, and may be formed of a material allowing gases to pass through and flames to block, such as fire-resistant foam pads (for example, urethane foam) or ceramic wool.

Referring to FIG. 6, the blocking member 92 may be disposed to contact an upper end of the barrier member 60 described above. Specifically, the barrier member 60 may be coupled to the blocking member 92 while compressing the blocking member 92 in a thickness direction, and accordingly, a portion of the blocking member 92 disposed on the upper end of the barrier member 60 may be elastically deformed and compressed by the barrier member 60, thereby increasing density of the portion. Therefore, it is possible to effectively prevent gas or flame from passing to the upper end of the barrier member 60.

As described above, in the battery device 1 of the present embodiment, a plurality of compartments S may be provided through a plurality of barrier members 60 and a blocking member 92, and at least one battery cell 7 may be distributed and disposed in each of the compartment S. Since in each of the compartment S, a blocking member 92 is disposed between the battery cells 7 and the upper plate 301, even if the battery cell 7 explodes, only gas among explosive by-products may pass through the blocking member 92, and the movement of flames, dust, or the like may be suppressed by the blocking member 92.

In addition, the first venting holes V1 and second venting holes V2 described above may be disposed to correspond to the compartments S. For example, in one of the compartments S, at least one among the first venting holes V1 and at least one among the second venting holes V2 may be disposed to correspond to each other. Therefore, even if explosion occurs in any one of the compartments S, since high temperature gas may be quickly discharged externally of the battery device 1 through the first venting hole V1 and the second venting hole V2, the explosion may be suppressed from diffusing to other compartments S.

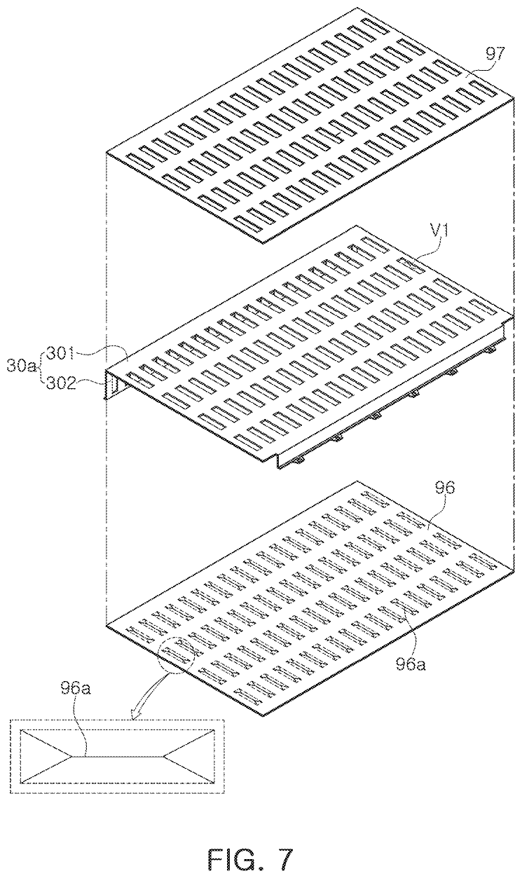

FIG. 7 is a perspective view of a first case and first and second protective sheets shown in FIG. 6. Referring to FIG. 7, the first protective sheet 96 may be disposed between the first case 30a and the blocking member 92. The first protective sheet 96 may be disposed on the cell stack 20 to prevent high-temperature gas passing through the blocking member 92 from directly contacting the case 30.

The first protective sheet 96 may have insulation performance, and may be formed of a member with flame retardancy or flame resistance. Here, flame retardant performance refers to performance to prevent diffusion of combustion, and flame retardant performance refers to performance to prevent combustion even if a fire occurs. Accordingly, the first protective sheet 96 may have combustibility to a degree that does not cause combustion to diffuse or may have non-flammable properties.

The first protective sheet 96 of the present embodiment may include a high-temperature fire-resistant insulating paper, and may be disposed on an entire lower surface of the upper plate 301 of the first case 30a. Accordingly, even if the battery cell 7 explodes, insulation may be secured between the battery cell 7 and the first case 30a. The high-temperature fire-resistant insulating paper may be formed of a material with high flammability resistance, arc resistance, and dielectric strength, so it can safely suppress electrical hazards. For example, the high-temperature fire-resistant insulating paper may be formed of an inorganic-based material, and may be formed of a material that shrinks very little or does not shrink at high temperatures.

A fractured portion 96a that is relatively vulnerable to pressure may be formed in the first protective sheet 96. The fracture portion 96a may be preferentially fractured when internal pressure of the battery device 1 increases. A plurality of fractured portions 96a may be formed in a region corresponding to the first venting hole V1, respectively, and the first protective sheet 96 may be formed to be relatively thin or the first protective sheet 96 may be partially cut, so that the fractured portions 96a may be formed so that the portion is fractured or is open at a lower pressure than other portions. However, the configuration of the present disclosure is not limited thereto.

When the fracture portion 96a is provided as described above, if the internal pressure of the battery device 1 increases, the fractured portion 96a may be fractured and explosive by-products such as gas may be discharged to externally of the battery device 1. In this case, if one of the plurality of fractured portions 96a is fractured, gas is discharged through the corresponding fractured portion 96a and the first venting hole V1 correspondingly, and the internal pressure of the battery device is reduced, so that other fractured portions 96a may remain unfractured. Accordingly, the first protective sheet 96 may block explosive by-products discharged externally of the battery device 1 from flowing into other battery cells 10 through the other venting hole V1.

The second protective sheet 97 may be disposed on an external surface of the first case 30a, that is, an upper surface of the upper surface plate 301, and a portion of the second protective sheet 97 corresponding to the first venting hole V1 may be open in a form of a through-hole. Since the battery device 1 of the present embodiment may be stored in a pack housing, or the like, which packs a plurality of battery devices 1, high-temperature gas that has passed therethrough and is discharged externally of the first venting hole V1 may be reflected from an inner surface of the pack housing to affect the upper plate 301.

Accordingly, the second protective sheet 97 may be disposed on the battery device 1 and provided to minimize the influence of high-temperature gas on the upper surface of the upper plate 301.

To this end, the second protective sheet 97 may have insulation performance and may be formed of a member with flame retardancy or flame resistance.

The second protective sheet 97 of the present embodiment may include mica, ceramic, silicon, and the like, and may be composed of a single thin sheet or formed by laminating thin sheets of different materials. For example, the second protective sheet 97 may be formed by laminating an insulating layer such as rubber or polyurethane on at least one surface of both surfaces of the mica sheet. However, the present disclosure is not limited thereto.

In the battery device 1 of the present embodiment described above, the battery cells 7 are disposed to be isolated in a plurality of compartments S partitioned by the barrier member 60 and the blocking member 92. In addition, the gas generated in each of the plurality of compartments S may not diffuse to other compartments S and may be discharged externally only through venting holes V1 and V2. Therefore, even if one of the battery cells 7 explodes, the explosion may be prevented from diffusing to other compartments S.

In addition, in the battery device 1 of the present embodiment, since gas generated in the battery cell 7 is discharged externally of the battery device 1 through two discharge paths consisting of a first venting hole V1 and a second venting hole V2, the gas may be discharged quickly and the influence of high temperature gas may be minimized.

As set forth above, according to an embodiment of the present disclosure, gas generated in the battery cell is discharged externally of the battery device through two discharge paths consisting of a first venting hole and a second venting hole, so that the gas may be quickly discharged, thereby minimizing the influence of high-temperature gas.

Only specific examples of implementations of certain embodiments are described. Variations, improvements and enhancements of the disclosed embodiments and other embodiments may be made based on the disclosure of this patent document.

For example, in the above-described embodiment, a case in which a terminal is disposed on a second case, rather than on a side plate, is illustrated, but the terminal may be disposed on the side plate.

What is claimed is:

1. A battery device, comprising:
a cell stack in which a plurality of battery cells are stacked; and
a case accommodating the cell stack therein,
wherein the case has a plurality of first venting holes formed in an upper plate covering an upper surface of the cell stack, and has a plurality of second venting holes formed in a side plate covering a first side surface of the cell stack.

2. The battery device of claim 1, wherein the cell stack comprises
a plurality of barrier members disposed between the plurality of battery cells to form a plurality of compartments,
at least one battery cell among the battery cells is disposed in one of the compartments, and
the plurality of first venting holes and the plurality of second venting holes are disposed in respective positions corresponding to each of the compartments.

3. The battery device of claim 2, wherein at least two first venting hole among the first venting holes and one second venting hole among the second venting holes are disposed to correspond to each other in one of the compartments.

4. The battery device of claim 2, further comprising:
a blocking member disposed between the upper plate and the cell stack,
wherein the blocking member is formed in a form of sheets covering an entire upper surface of the cell stack, and is disposed to contact upper ends of the barrier members.

5. The battery device of claim 4, wherein a portion of the blocking member, in contact with the barrier members is compressed and elastically deformed by the barrier members.

6. The battery device of claim 4, wherein the blocking member comprises fire-resistant foam pads or ceramic wool.

7. The battery device of claim 4, further comprising:
a first protective sheet disposed between the blocking member and the upper plate,
wherein the first protective sheet includes a fractured portion located in a portion of the first protective sheet corresponding to the first venting holes and fractured at a lower pressure than other portions of the first protective sheet.

8. The battery device of claim 7, wherein the first protective sheet comprises a high-temperature fire-resistant insulating paper.

9. The battery device of claim 4, further comprising:
a second protective sheet disposed on an external surface of the upper plate,
wherein a portion of the second protective sheet corresponding to the first venting holes is open.

10. The battery device of claim 9, wherein the second protective sheet comprises mica sheets.

11. The battery device of claim 2, wherein the plurality of barrier members are formed of a material including at least one of mica, metal, and a resin.

12. The battery device of claim 1, further comprising:
a busbar assembly disposed between the side plate and the cell stack, and a busbar cover disposed between the busbar assembly and the side plate,
wherein the busbar cover includes a plurality of venting guides formed in a form of through-holes, and
the second venting holes are disposed in a region corresponding to the plurality of venting guides.

13. The battery device of claim 12, further comprising:
an anti-diffusion pad coupled to the busbar cover in a form of blocking the plurality of venting guides and suppressing a flow of flame or dust.

14. The battery device of claim 13, wherein the anti-diffusion pad comprises a mesh net formed of ceramic wool or metal.

15. The battery device of claim 1, wherein the case comprises a support frame disposed below the cell stack to partially support a lower surface of the cell stack,
wherein a portion of the lower surface of the cell stack is exposed externally of the case.

16. The battery device of claim 1, wherein in the upper plate, a total area of openings formed by the plurality of first venting holes is 40% or more as compared to a total area of the upper plate.
